(19) United States
(12) Patent Application Publication
(10) Pub. No.: US 2026/0147863 A1
(43) Pub. Date: May 28, 2026

(54) Leveraging Noise Cancelling Technology for Dynamic Voice Authentication

(71) Applicant: Bank of America Corporation, Charlotte, NC (US)

(72) Inventors: Ramesh Gopalakrishnan, Simi Valley, CA (US); Prathima Attluri, Beeramguda (IN); Maneesh Kumar Sethia, Hyderabad (IN); Raghunathan Mohan, Madipakkam (IN); Basavaraj Annigeri, West Chester, PA (US)

(21) Appl. No.: 18/961,666

(22) Filed: Nov. 27, 2024

(51) Int. Cl. G06F 21/32; G10L 17/02; G10L 17/06; G10L 17/20; G10L 21/0232

(52) U.S. Cl. CPC G06F 21/32; G10L 17/02; G10L 17/06; G10L 17/20; G10L 21/0232

(57) ABSTRACT

Arrangements for leveraging noise cancelling technology for dynamic voice authentication are provided. In some examples, a computing platform may receive audio data, such as from a user via a mobile device. Based on receiving the data, the computing platform may initiate a transaction session and may activate one or more noise cancelling techniques. The audio data may be compared to pre-stored data to authenticate the user. If the user is not authenticated, the transaction session may be terminated. If the user is authenticated, features may be extracted from the audio data to format the data for further processing. Speech recognition techniques may be executed on the formatted data to generate an output. For instance, one or more machine learning models may be executed to convert the data to phonetic units, predict a word or sequence of words, or the like. The output generated may be output for confirmation.

### BACKGROUND

Aspects of the disclosure relate to electrical computers, systems, and devices for leveraging noise cancelling technology for dynamic voice authentication.

Current authentication systems for processing transactions may be cumbersome and may rely on user input to, for instance, a user device, a merchant point-of-sale system, or the like. In some examples, communication between user devices and point-of-sale systems may be used for authentication. However, that can be time consuming and prone to network or connectivity issues at the point-of-sale system. Accordingly, arrangements described herein rely on dynamic voice authentication leveraging noise cancelling technology to securely authenticate a user in order to process a transaction.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with providing secure, dynamic voice authentication.

In some examples, a computing platform may receive audio data. For instance, audio data may be received from a user via a mobile device of a user, such as a wearable device. Based on receiving the data, the computing platform may initiate a transaction session and may activate one or more noise cancelling techniques to isolate audio data, remove noise, improve quality, and the like. The audio data may be compared to pre-stored data to authenticate the user. If the user is not authenticated, the transaction session may be terminated.

If the user is authenticated, features may be extracted from the audio data to format the data for further processing. In some examples, speech recognition techniques may be executed on the formatted data to generate an output. For instance, one or more machine learning models may be executed to convert the data to phonetic units, predict a word or sequence of words, or the like. The output generated may be further processed for error correction and may be output for confirmation.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for leveraging noise cancelling technology for dynamic voice authentication in accordance with one or more aspects described herein;

FIGS. 2A-2E depict an illustrative event sequence for leveraging noise cancelling technology for dynamic voice authentication in accordance with one or more aspects described herein;

FIG. 3 illustrates an illustrative method for leveraging noise cancelling technology for dynamic voice authentication according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional arrangements rely on user authentication data being provided via a user device or merchant point-of-sale system, which may be cumbersome and prone to connectivity issues, privacy issues, and the like. Accordingly, the arrangements described herein provide for a sound bubble to be generated around a user in order to securely capture and provide audio data to the user in order to authenticate the user, process transactions, and the like. As discussed herein, artificial intelligence trust, risk and security management (AI TRiSM) and cognitive artificial intelligence may be used to ensure comprehensive protection against threats posed by deep fakes and other cybersecurity threats.

These and various other arrangements will be discussed more fully below.

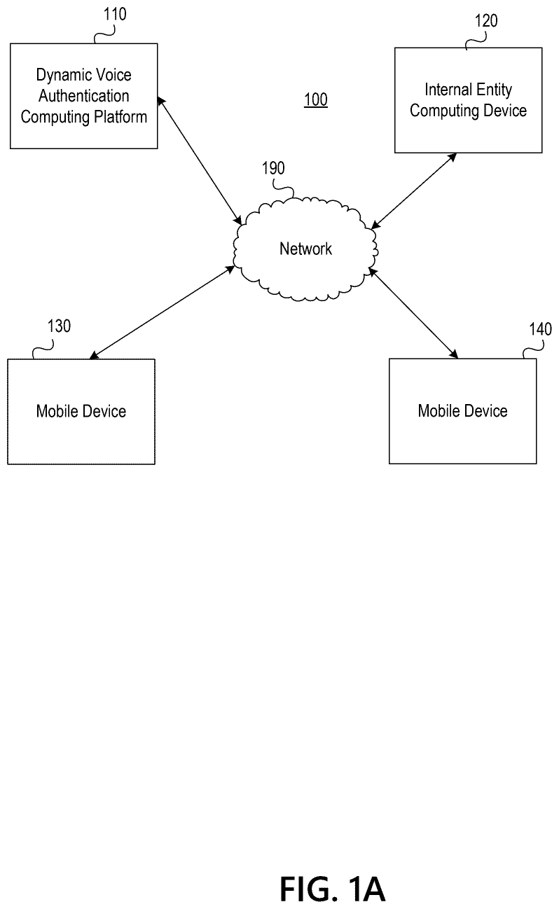

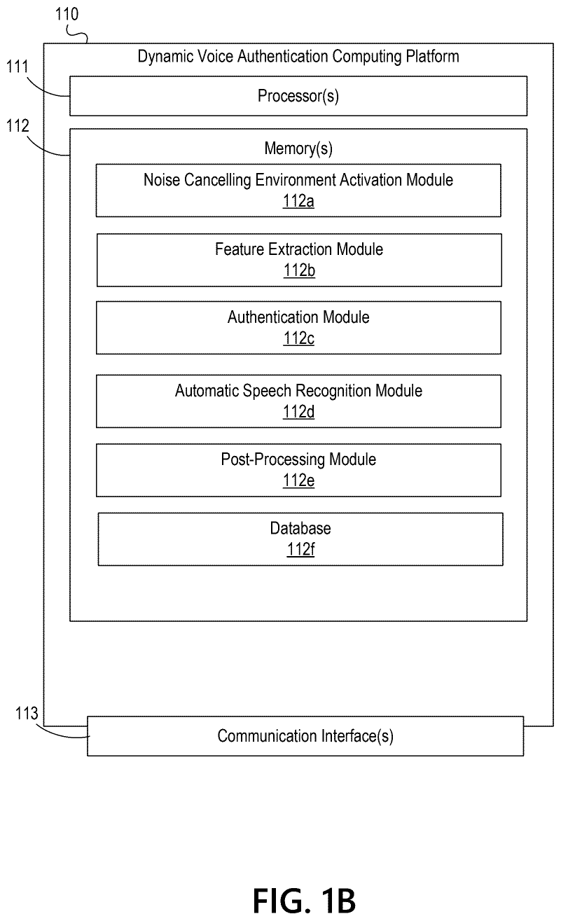

FIGS. 1A-1B depict an illustrative computing environment and devices for leveraging noise cancelling technology for dynamic voice authentication in accordance with one or more aspects described herein. Referring to FIG. 1A, computing environment 100 may include one or more computing devices and/or other computing systems. For example, computing environment 100 may include dynamic voice authentication computing platform 110, internal entity computing device 120, mobile device 130 and mobile device 140.

Although one internal entity computing device 120 and two mobile devices 130, 140 are shown, any number of systems or devices may be used without departing from the invention.

Dynamic voice authentication computing platform 110 may be or include one or more computer components (e.g., servers, server blade, processor, memory, and the like) and may be configured to perform intelligent, dynamic, voice authentication functions. For instance, dynamic voice authentication computing platform 110 may receive audio data, such as spoken words or utterances from a user via a mobile device of a user, such as mobile device 130, mobile device 140, or the like. Dynamic voice authentication computing platform 110 may pre-process the audio data to remove noise and enhance clarity of the audio signal. In some examples, sound bubble may be generated around the user and user device to further reduce background noise and improve quality of the signal.

Dynamic voice authentication computing platform 110 may then extract one or more features from the audio data. For instance, the audio data may be further processed using, for instance, mel-frequency cepstral coefficients (MFCCs), spectrograms, centroid, roll-off, and/or phase cancellation to convert the audio signal to a suitable format for further processing.

Dynamic voice authentication computing platform 110 may authenticate the user based on the audio data. For instance, based on the features extracted and the processing of the audio data, the audio data may be compared to pre-stored authentication data, as well as user identifying data, to determine whether the user is authenticated (e.g., user identifiers match and authentication data matches pre-stored data). If not, the transaction session may be terminated. If so, the audio data may be further processed to determine transaction details and generate an output in response to the audio data.

In some examples, dynamic voice authentication computing platform 110 may perform automatic speech recognition on the processed audio data. In some examples, one or more machine learning models may be used to predict a word or sequence of words. For example, the machine learning models may be used to analyze the audio data to predict a sequence of words requesting a transaction, providing transaction details, or the like. In some arrangements, artificial intelligence trust, risk and security management (AI TRiSM) may provide a framework to ensure security of the data processing and manage outputs. The automatic speech recognition may generate an output which may, in some examples, be further processed by the dynamic voice authentication computing platform 110 to perform error correction, text formatting, and the like. The dynamic voice authentication computing platform 110 may convert final output text to speech and may provide the output to the user via the mobile device 130 of the user. The user may then provide feedback that may be used to update the one or more machine learning models. In some examples, the one or more machine learning models may be executed in series such that an output from one model may be used as an input in another model.

Internal entity computing device 120 may be or include one or more computing devices (e.g., laptop computers, desktop computers, mobile devices, tablet devices, or the like) that may be used by an employee, agent, associate or other user of the enterprise organization implementing the dynamic voice authentication computing platform 110. In some examples, internal entity computing device 120 may be used to capture data for use in training or validating one or more machine learning models, may adjust or control the dynamic voice authentication computing platform 110, may receive and display notifications from the dynamic voice authentication computing platform 110, pay process one or more transactions, and the like.

Mobile device 130 and/or mobile device 140 may be or include one or more mobile computing devices (e.g., smart phones, wearable devices, tablet devices, or the like) that may be configured to communicate via a cellular network or a wireless data network. Mobile device 130 and/or mobile device 140 may receive and provide text and audio data that may be transmitted to the dynamic voice authentication computing platform 110 for processing.

As mentioned above, computing environment 100 also may include one or more networks, which may interconnect one or more of dynamic voice authentication computing platform 110, internal entity computing device 120, mobile device 130 and/or mobile device 140. For example, computing environment 100 may include network 190. Network 190 may, in some examples, be a private network and include one or more sub-networks (e.g., Local Area Networks (LANs), Wide Area Networks (WANs), or the like). Network 190 may interconnect one or more computing devices associated with the organization. For example, dynamic voice authentication computing platform 110, internal entity computing device 120, mobile device 130 and/or mobile device 140 may be connected via network 190.

Referring to FIG. 1B, dynamic voice authentication computing platform 110 may include one or more processors 111, memory 112, and communication interface 113. A data bus may interconnect processor(s) 111, memory 112, and communication interface 113. Communication interface 113 may be a network interface configured to support communication between dynamic voice authentication computing platform 110 and one or more networks (e.g., network 190, or the like). Memory 112 may include one or more program modules having instructions that when executed by processor(s) 111 cause dynamic voice authentication computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of dynamic voice authentication computing platform 110 and/or by different computing devices that may form and/or otherwise make up dynamic voice authentication computing platform 110.

For example, memory 112 may have, store and/or include noise cancelling environment activation module 112a. Noise cancelling environment activation module 112a may store instructions and/or data that may cause or enable the dynamic voice authentication computing platform 110 to activate a noise cancelling environment at a mobile device of a user (such as mobile device 130, mobile device 140, or the like). In some examples, noise cancelling environment activation module 112a may store further instructions to execute one or more noise cancelling techniques in order to generate a sound bubble around a user or user device, reduce noise in audio data, improve signal quality, or the like.

In some examples, techniques such as signal processing, noise reduction, and/or sound bubble technology may be used to create a silent zone around the user, enhance clarity of audio signals, remove noise and improve the quality of the audio signal and/or data. In some examples, sound bubble technology may manipulate propagation and behavior of sound waves in a controlled manner, leveraging principles of wave interference, resonance, and directional control to shape how sound behaves in specific spaces, aiming to enhance acoustic comfort, privacy, and/or clarity. For instance, techniques such as active noise control (ANC) in the context of wave formation involves using principles of wave interference to reduce or cancel unwanted sound waves, thereby reducing overall noise levels in specific areas or devices. ANC relies on the principle of wave interference, which may occur when two or more waves overlap in a medium. Waves can either reinforce each other (constructive interference) or cancel each other out (destructive interference), depending on their relative phase. This may cause conversion of sound waves into electrical signals that represent the amplitude and phase of the incoming sound.

Further, the generated anti-phase waves may then be emitted through speakers or transducers placed strategically in the environment. When the anti-phase waves combine with the incoming sound waves, they interfere destructively. This means that the peaks of one wave align with the troughs of the other wave, leading to cancellation of the sound energy at specific points in space where both waves are present simultaneously.

In some examples, ANC is particularly effective for canceling out steady, low-frequency noises such as engine hums or air conditioning noise. It may be suited to environments where the characteristics of the noise are relatively predictable and there are few significant delays between the generation of the original sound and the emission of the anti-phase sound.

In another example technique, sound masking may include emitting a background sound, typically a low-level, broadband noise, to mask or cover up other sounds. This technique may add a constant sound to an environment, making other sounds less noticeable or distracting and may be suited to offices to improve speech privacy and reduce distractions.

Additionally or alternatively, certain materials and structures may be configured to absorb, reflect, and/or diffuse sound waves. Acoustic panels, for example, absorb sound waves by converting acoustic energy into heat through friction within the panel's material. This may reduce the sound energy bouncing around a room and may help control reverberation and echoes.

In some arrangements, technologies such as directional speakers or focused sound beams may be used to direct sound waves towards specific locations or listeners. By focusing sound energy, these systems can create “sound bubbles” where sound is audible only within a defined area or direction, minimizing sound spill and improving clarity.

In some applications, sound bubbles can be created through controlled resonance and interference patterns. By manipulating the frequency and phase of sound waves, areas can be created where sound is amplified or attenuated selectively, providing customized acoustic environments.

Dynamic voice authentication computing platform 110 may further have, store and/or include feature extraction module 112b. Feature extraction module 112b may store instructions and/or data that may cause or enable the dynamic voice authentication computing platform 110 to format the audio signal for further processing. For instance, MFCCs, spectrograms, centroid, rolloff, and the like, may contribute to creation of a silent zone/noise cancellation in order to format the audio signal for further processing.

Dynamic voice authentication computing platform 110 may further have, store and/or include authentication module 112c. Authentication module 112c may store instructions and/or data that may cause or enable the dynamic voice authentication computing platform 110 to evaluate the speaker or user associated with the audio data, retrieve a user identifier (e.g., based on machine learning, pre-stored data, or the like), compare the user identifier to the user and compare a spoken password or other authentication data to pre-stored authentication data. If the user identifier and authentication data do not match, the transaction may be terminated. If a match exists, the transaction may proceed.

Dynamic voice authentication computing platform 110 may further have, store and/or include automatic speech recognition module 112d. Automatic speech recognition module 112d may store instructions and/or data that may cause or enable the dynamic voice authentication computing platform 110 to receive the formatted audio data and convert the data to phonetic units. In some examples, an AITRiSM framework may be used to execute one or more machine learning models in order to analyze data and generate one or more outputs. For instance, deep learning models such as hidden Markov model (HMM), convolutional neural network (CNN), recurrent neural network (RNN), Long Short-Term Memory (LSTM) attention masking, and the like, may be used to convert the data to phonetic units. One or more additional models, such as language models, lexicon pronunciation model, n-gram models, RNN, and the like, may be used to predict words or sequence of words, in order to generate an output.

Dynamic voice authentication computing platform 110 may further have, store and/or include post-processing module 112e. Post-processing module 112e may store instructions and/or data that may cause or enable the dynamic voice authentication computing platform 110 to receive the output and execute error correction and/or formatting in order to improve accuracy and readability of the output. The post-processing module 112e may provide a final transcribed output as text or audio data and may receive confirmation from the user device of the output.

Dynamic voice authentication computing platform 110 may further have, store and/or include database 112f. Database 112f may store data related to training one or more machine learning models, pre-stored authentication data, user identifier data, and/or other data to perform he functions of the dynamic voice authentication computing platform 110.

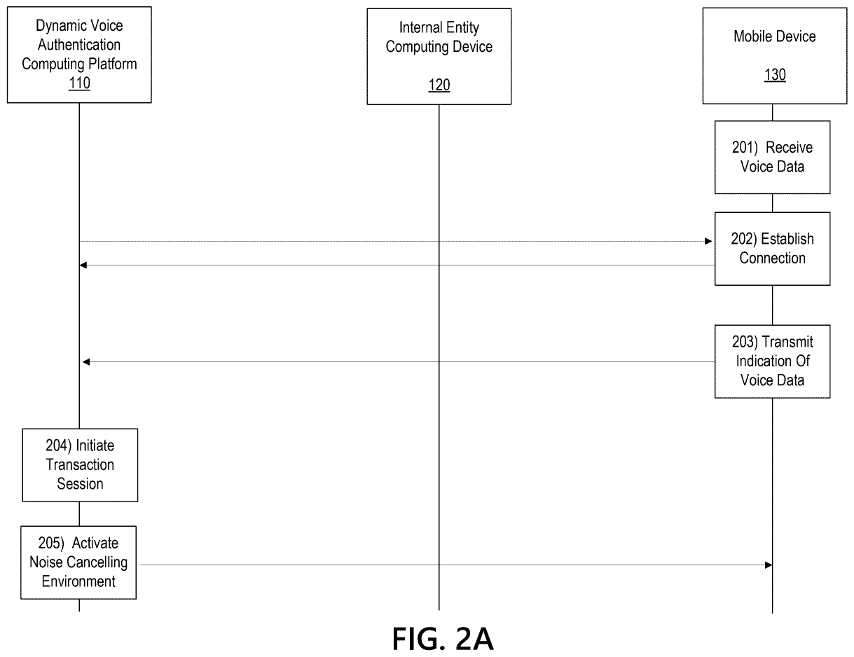

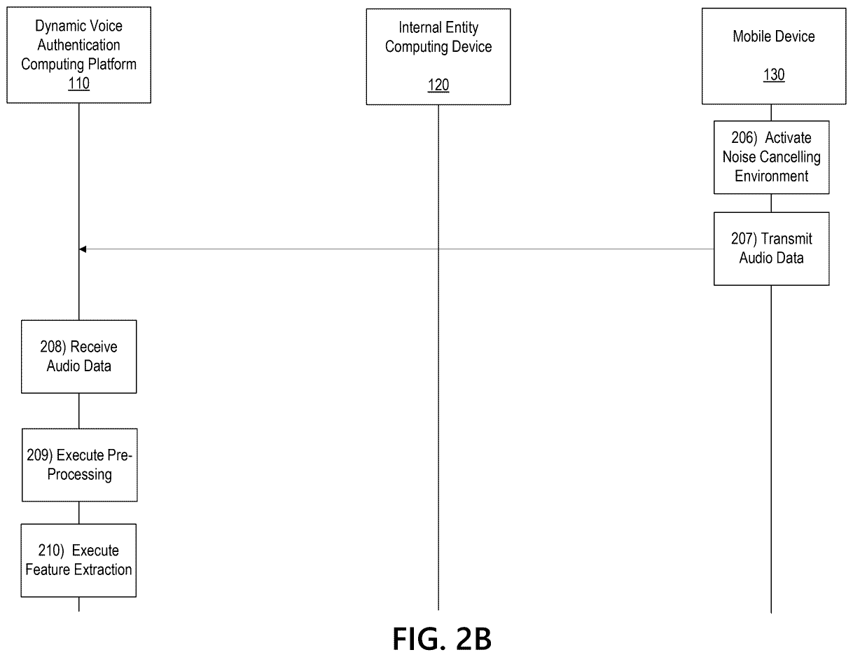

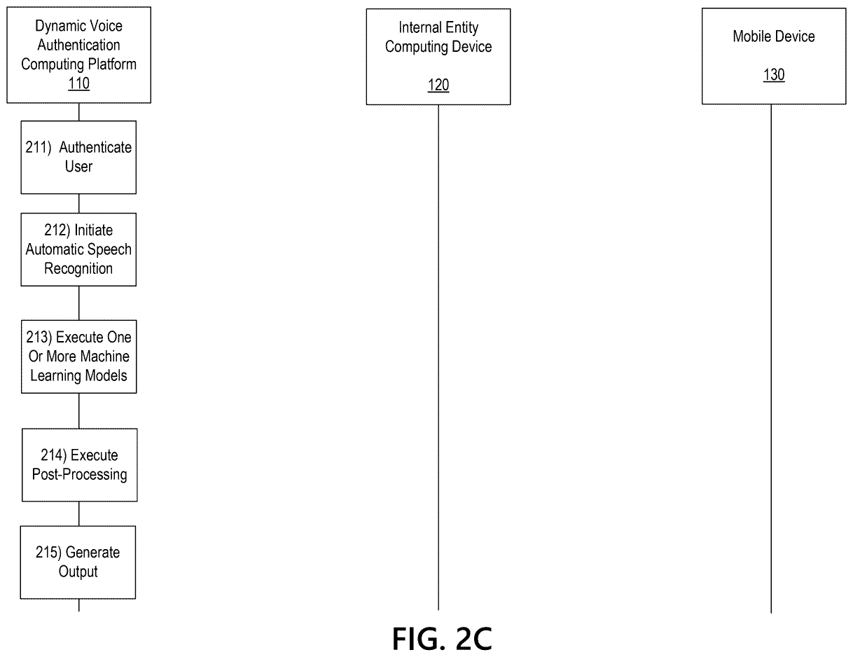

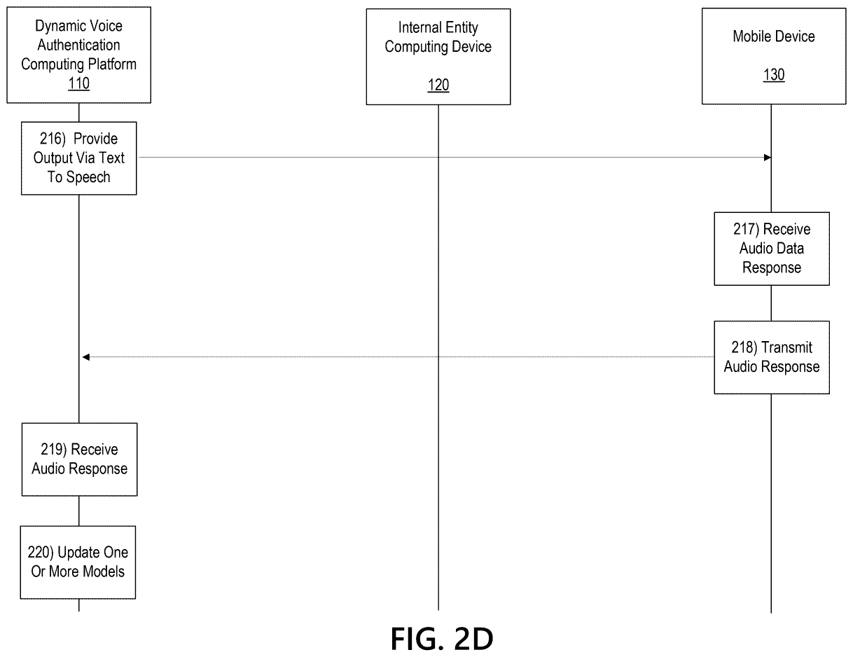

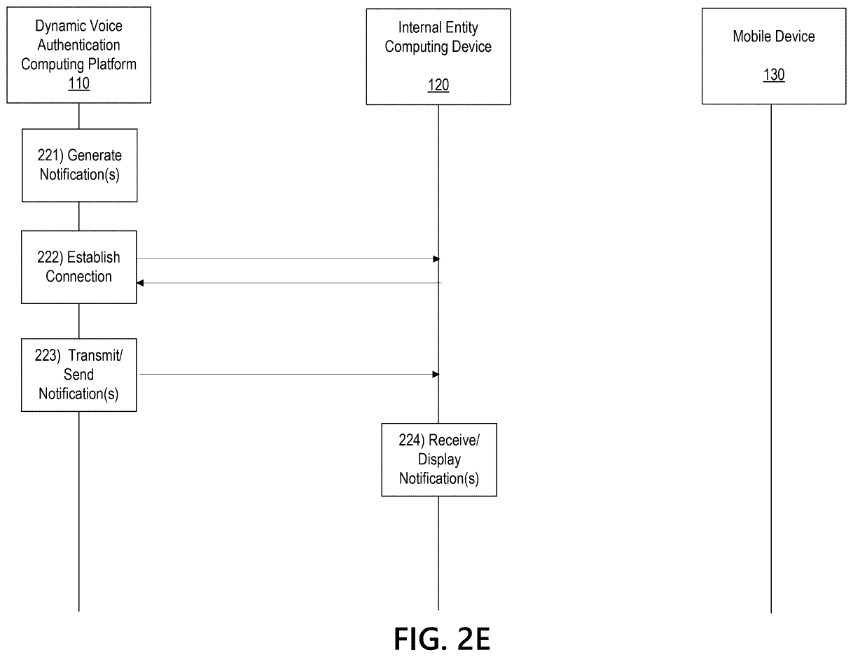

FIGS. 2A-2E depict one example illustrative event sequence for leveraging noise cancelling technology for dynamic authentication and transaction processing in accordance with one or more aspects described herein. The events shown in the illustrative event sequence are merely one example sequence and additional events may be added, or events may be omitted, without departing from the invention. Further, one or more processes discussed with respect to FIGS. 2A-2E may be performed in real-time or near real-time.

With reference to FIG. 2A, at step 201, a mobile device of a user, such as mobile device 130, may detect or receive voice data. For instance, the mobile device 130 of the user may capture, via a speak in the mobile device 130, audio data spoken by the user. In some examples, the audio data may include a request for transaction, password or other authentication data, transaction details, and the like.

Upon detecting or receiving the voice data, a step 202, mobile device 130 may establish a wireless data connection with dynamic voice authentication computing platform 110. For instance, mobile device 130 may establish a first wireless data connection with dynamic voice authentication computing platform 110. Upon establishing the first wireless data connection, a communication session may be initiated between dynamic voice authentication computing platform 110 and mobile device 130.

At step 203, mobile device 130 may transmit an indication that audio data was received to the dynamic voice authentication computing platform 110. For instance, the indication that audio data was received may be transmitted or sent during the communication session initiated upon establishing the first wireless data connection.

At step 204, dynamic voice authentication computing platform 110 may receive the indication of audio data and, in response, initiate a transaction session with the mobile device 130 and associated user.

At step 205, dynamic voice authentication computing platform 110 may activate a noise cancelling environment. For instance, dynamic voice authentication computing platform 110 may transmit or send, to the mobile device 130, an instruction or command causing activation of one or more noise cancelling techniques at the mobile device 130. In some examples, the noise cancelling environment may include one or more sound bubble and/or anti-noise processes that may occur at the mobile device 130 and/or may be performed by the dynamic voice authentication computing platform 110.

With reference to FIG. 2B, at step 206, mobile device 130 may receive the instruction activating the noise cancelling environment and may execute the instruction to activate the noise cancelling environment. In some examples, activating the noise cancelling environment may include activating one or more devices (e.g., speakers, transducers, and the like) at or around the user or mobile device 130 to create a silent zone around the user or mobile device 130.

In some examples, steps 201 to 206 may be performed near simultaneously and in real-time.

At step 207, the mobile device 130 may transmit or send the received audio data to the dynamic voice authentication computing platform 110.

At step 208, the dynamic voice authentication computing platform 110 may receive the audio data.

At step 209, the dynamic voice authentication computing platform 110 may execute pre-processing functions on the audio data. For instance, one or more noise cancelling or sound enhancing techniques may be executed on the audio data. For instance, signal processing to remove noise and/or noise reduction to enhance clarity of the audio signal may be performed. Further, the anti-noise techniques activated may improve quality of subsequent audio data captured during the transaction session (e.g., after authenticating the user, requests for transaction, transaction details, or the like that may be provided via audio data to the mobile device 130).

At step 210, the dynamic voice authentication computing platform 110 may execute one or more feature extraction processes to convert the audio data to a suitable format for further processing. For instance, MFCCs, centroid, rolloff, spectrograms, phase cancellation, and the like, may be performed on the audio signal to format the signal for further processing. In some examples, the phase cancellation may be used to identify or recognize data for extraction.

With reference to FIG. 2C, at step 211, dynamic voice authentication computing platform 110 may authenticate the user. For instance, the captured voice data may be compared to a user identifier to determine whether the voice matches that of an expected user (e.g., matches pre-stored data). Further, the audio data providing a password or other authenticating data may be compared to pre-stored data to determine whether the data matches. If the user identifier or the authentication data does not match, the dynamic voice authentication computing platform 110 may terminate the transaction session (e.g., disconnect the communication session between the dynamic voice authentication computing platform 110 and the mobile device 130).

In some examples, step 211 of authenticating the user may be performed on the pre-processed data (e.g., before feature extraction processes are performed at step 210).

If the user identifier and authentication data match, at step 212, dynamic voice authentication computing platform 110 may initiate automatic speech recognition processes. For instance, the dynamic voice authentication computing platform 110 may analyze the audio data using one or more automatic speech recognition processes. In some examples, the audio data may include additional data related to a transaction being processed (e.g., type of transaction, amount, or the like). In some arrangements, the automatic speech recognition techniques may be used to analyze the audio data and predict words or sequences or words from the audio data. In some examples, these techniques may be used to analyze subsequently captured audio data in the same transaction session (e.g., additional audio data provided by the user).

In some examples, dynamic voice authentication computing platform may execute one or more machine learning models at step 213. For instance, an AITRiSM framework may be used to mitigate risk associated with algorithmic bias, data breaches and misuse, and the like. In some examples, the AITRiSM framework may provide continuous monitoring of models and output to detect anomalies and bias, may retrain models and maintain version control of models, encrypting model data and implementing access controls around development systems, and/or enable privacy enhancing techniques. Accordingly, the AITRiSM framework may provide a foundation for one or more machine learning models to analyze audio data, predict words or sequences or words, generate outputs, and the like.

In some examples, the one or more models for execution may include large language models (LLMs), deep learning models, acoustic models, lexicon/pronunciation models, and the like. In some examples, the outputs or probabilities generating by acoustic and language models may be combined using, for instance, algorithms such as Viterbi or beam search, to generate the most likely words or sequence or words. The models may be executed to convert the audio features into phonetic units and output a word or sequences or words from the audio data. In some arrangements, decoders may be used to address time lag in the audio data. In some arrangements, one or more models may be executed in series such that an output of one model may be used as an input to another model.

At step 214, in some examples, dynamic voice authentication computing platform 110 may execute one or more post-processing functions. For instance, the output from the automatic speech recognition functions may be formatted to improve readability, and accuracy.

At step 215, dynamic voice authentication computing platform 110 may generate a final output.

With reference to FIG. 2D, at step 216, dynamic voice authentication computing platform 110 may transmit or send the final output to the mobile device 130. In some examples, transmitting the final output to the mobile device 130 may cause the final output to be displayed by a display of the mobile device 130 and/or a text to speech conversion may cause the final output to be audibly provided to the user via the mobile device 130.

At step 217, in response to the displayed or provided final output, the user may provide, via the mobile device 130, confirmation of the final output as response data. In some examples, the response data may include voice or audio data providing confirmation or indicating errors.

At step 218, mobile device 130 may transmit or send the response data to the dynamic voice authentication computing platform 110.

At step 219, dynamic voice authentication computing platform 110 may receive the response data.

At step 220, based on the response data, dynamic voice authentication computing platform 110 may update, validate and/or retrain the one or more machine learning models.

While aspects described are directed to processing audio data for authenticating a user, in some examples, after authenticating the user, the processes, models, analysis, and the like, described herein may be used to receive and analyze additional audio data provided by the user in the course or requesting and/or processing a transaction (e.g., audio data identifying a type of transaction, account for processing the transaction, amount of transaction or other transaction details, and the like). Accordingly, after authenticating the user, the dynamic voice authentication computing platform 110 may receive additional audio data that may be captured in the noise cancelling environment of the transaction session and processed according to steps 208-220.

With reference to FIG. 2E, at step 221, dynamic voice authentication computing platform 110 may generate one or more notifications. For instance, dynamic voice authentication computing platform 110 may generate one or more notifications indicating that a user is authenticated, providing additional transaction information, indicating errors or inaccuracies in final outputs, or the like.

At step 222, dynamic voice authentication computing platform 110 may establish a wireless data connection with internal entity computing device 120. For instance, dynamic voice authentication computing platform 110 may establish a second wireless data connection with internal entity computing device 120. Upon establishing the second wireless data connection, a communication session may be initiated between dynamic voice authentication computing platform 110 and internal entity computing device 120.

At step 223, dynamic voice authentication computing platform 110 may transmit or send the generated notification(s) to the internal entity computing device 120. In some examples, transmitting or sending the notification(s) may cause the internal entity computing device 120 to display the notification(s) on a display of internal entity computing device 120.

At step 224, internal entity computing device 120 may receive and display the notification(s).

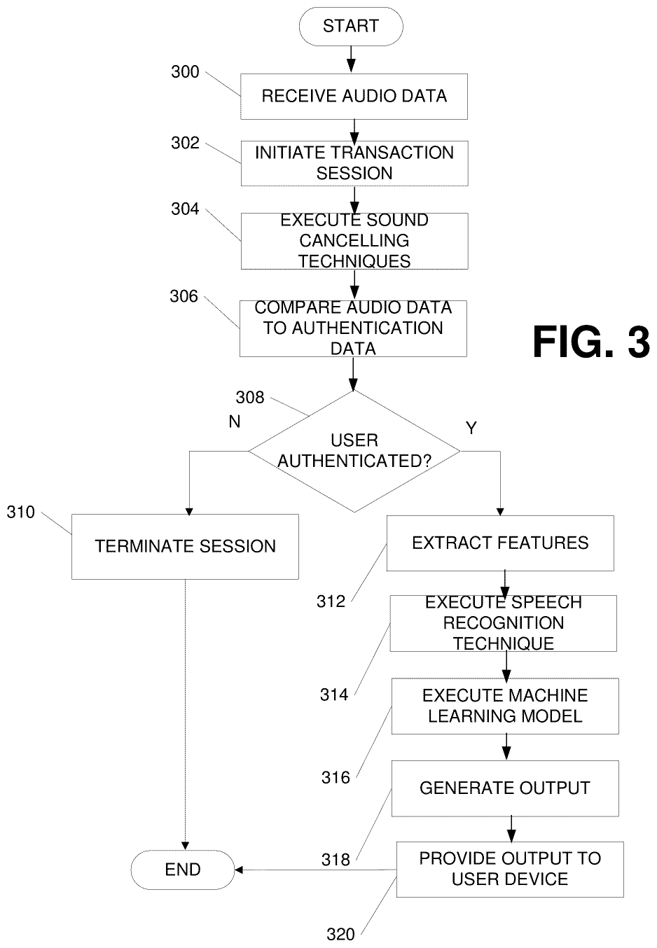

FIG. 3 is a flow chart illustrating one example method for leveraging noise cancelling technology for dynamic voice authentication in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, dynamic voice authentication computing platform 110 may receive audio data. For instance, the audio data may include spoken data provided by a user to a mobile device of the user, such as mobile device 130, mobile device 140, or the like. The audio data may include authentication data, transaction request data, or the like.

At step 302, dynamic voice authentication computing platform 110 may initiate a transaction session. For instance, based on receiving the audio data, the dynamic voice authentication computing platform may initiate a transaction session in which audio data provided by the user via the user device is processed and an output is generated in response.

At step 304, the dynamic voice authentication computing platform 110 may execute one or more noise or sound cancelling techniques. For instance, one or more sound cancelling techniques may be executed by the mobile device of the user (e.g., mobile device 130, mobile device 140, or the like), by the dynamic voice authentication computing platform 110, or the like. In some examples, signal processing and noise reduction techniques may be executed to remove noise and enhance clarity of the audio data. Additionally or alternatively, a sound bubble may be generated around the user and user device (e.g., based on an instruction or command generated by dynamic voice authentication computing platform 110 and sent to one or more of the user mobile device and/or other devices). The sound bubble may create a silent zone around the user to further reduce background noise and improve quality of the audio data.

At step 306, the audio data may be compared to pre-stored authentication data and a user identifier to authenticate the user. For instance, the audio data may include a password and the mobile device may provide a user identifier associated with the user. This data may be compared to pre-stored data to authenticate the user to the initiated transaction session.

At step 308, dynamic voice authentication computing platform 110 may determine whether the user is authenticated (e.g., whether authentication data and user identifier match pre-stored data). If not, at step 310, the transaction session may be terminated by the dynamic voice authentication computing platform 110.

If, at step 308, the user is authenticated, dynamic voice authentication computing platform 110 may extract features from the audio data and further process the data to format the data to a format suitable for additional processing at step 312. For instance, MFCCs, spectrogram, centroid, roll-off, phase cancellation, and the like, may be used to format the data to a suitable format.

At step 314, dynamic voice authentication computing platform 110 may execute one or more automatic speech recognition techniques within an AITRiSM framework. For instance, the audio data may be converted to one or more phonetic units (e.g., using one or more machine learning models) and, at step 316, one or more machine learning models may be executed on the data (e.g., phonetic data may be used as inputs to one or more models) to predict a sequence of words or output in response to the audio data. For instance, one or more deep learning models, encoders, decoders, acoustic models, and the like, may be executed to predict a likely word or sequence of words.

At step 318, the output may be generated and, in some examples, dynamic voice authentication computing platform 110 may post-process the output to correct errors, and the like. The output may then be provided to the user at step 320. For instance, the text may be converted to speech and provided to the user (e.g., within the generated sound bubble) via the mobile device 130 of the user. The user may then provide feedback data (e.g., confirming the output) which may be used to update and/or validate the one or more models.

In some examples, additional audio data may be received and analyzed and/or the transaction may be processed based on the analysis of the audio data and/or additional audio data received and analyzed.

Accordingly, aspects provided herein may be used to securely authenticate a user and/or process a transaction using audio data. As discussed herein, leveraging noise cancelling technology, as well as AITRiSM, provides improved security and privacy, while enhancing anomaly detection and improving recognition of deepfakes. By integrating AITRiSM with noise reduction in real-time, and using machine learning architecture for voice analysis, the arrangements described provide comprehensive protection against threats posed by deepfake artificial intelligence with embedded noise snippets of sound bubble tech.

Accordingly, by providing secure voice authentication, the arrangements described herein improve efficiency of authenticating users and executing transactions.

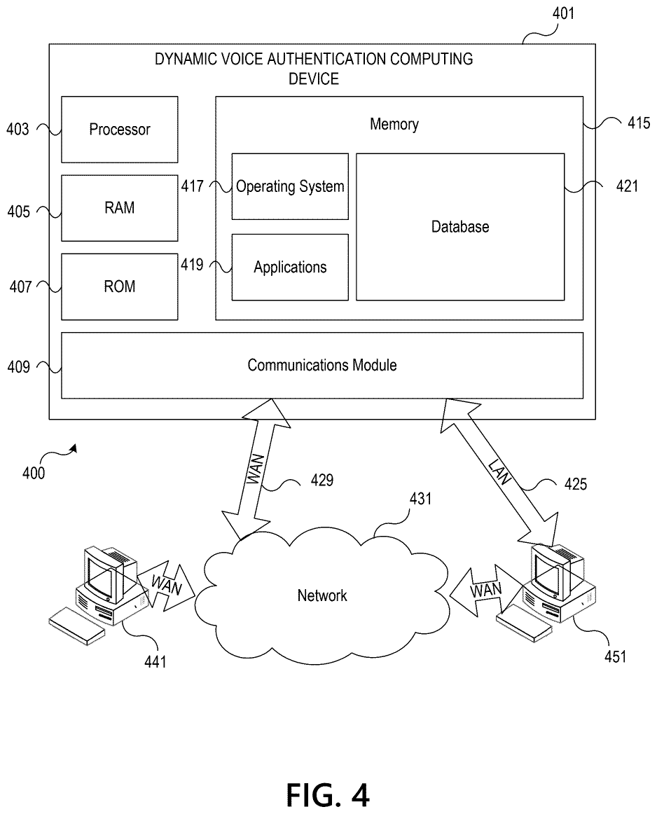

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include dynamic voice authentication computing device 401 having processor 403 for controlling overall operation of dynamic voice authentication computing device 401 and its associated components, including Random Access Memory (RAM) 405, Read-Only Memory (ROM) 407, communications module 409, and memory 415. Dynamic voice authentication computing device 401 may include a variety of computer readable media. Computer readable media may be any available media that may be accessed by dynamic voice authentication computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by dynamic voice authentication computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on dynamic voice authentication computing device 401. Such a processor may execute computer-executable instructions stored on a computer-readable medium.

Software may be stored within memory 415 and/or storage to provide instructions to processor 403 for enabling dynamic voice authentication computing device 401 to perform various functions as discussed herein. For example, memory 415 may store software used by dynamic voice authentication computing device 401, such as operating system 417, application programs 419, and associated database 421. Also, some or all of the computer executable instructions for dynamic voice authentication computing device 401 may be embodied in hardware or firmware. Although not shown, RAM 405 may include one or more applications representing the application data stored in RAM 405 while dynamic voice authentication computing device 401 is on and corresponding software applications (e.g., software tasks) are running on dynamic voice authentication computing device 401.

Communications module 409 may include a microphone, keypad, touch screen, and/or stylus through which a user of dynamic voice authentication computing device 401 may provide input, and may also include one or more of a speaker for providing audio output and a video display device for providing textual, audiovisual and/or graphical output. Computing system environment 400 may also include optical scanners (not shown).

Dynamic voice authentication computing device 401 may operate in a networked environment supporting connections to one or more remote computing devices, such as computing devices 441 and 451. Computing devices 441 and 451 may be personal computing devices or servers that include any or all of the elements described above relative to dynamic voice authentication computing device 401.

The network connections depicted in FIG. 4 may include Local Area Network (LAN) 425 and Wide Area Network (WAN) 429, as well as other networks. When used in a LAN networking environment, dynamic voice authentication computing device 401 may be connected to LAN 425 through a network interface or adapter in communications module 409. When used in a WAN networking environment, dynamic voice authentication computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive audio data from a user, wherein the audio data is captured by a mobile device of the user and the audio data is received via the mobile device of the user;
initiate, based on the received audio data, a transaction session;
execute sound cancelling techniques to isolate the audio data;
compare the audio data to pre-stored user authentication data to determine whether the user is authenticated to the transaction session;
responsive to determining that the user is not authenticated to the transaction session, terminate the transaction session;
responsive to determining that the user is authenticated to the transaction session:
extract, from the audio data, features, wherein extracting the features results in an audio signal formatted for further processing;
execute one or more speech recognition techniques on the audio signal to generate a plurality of phonetic units;
execute one or more machine learning models, wherein executing the one or more machine learning models includes inputting, to the one or more machine learning models, the plurality of phonetic units to generate an output; and
transmit, to the mobile device of the user, the generated output for confirmation.

2. The computing platform of claim 1, further including instructions that, when executed, cause the computing platform to:
receive, in response to transmitting the generated output, feedback data; and
update the one or more machine learning models based on the feedback data.

3. The computing platform of claim 1, wherein extracting the features includes executing one or more of: mel-frequency cepstral coefficients (MFCCs) or spectrograms.

4. The computing platform of claim 1, wherein executing the one or more speech recognition techniques includes executing one or more of deep learning models, acoustic models or language models.

5. The computing platform of claim 1, further including instructions that, when executed, cause the computing platform to:
post-process the output to improve accuracy of the output.

6. The computing platform of claim 5, wherein the post-processing includes error correction.

7. The computing platform of claim 5, wherein the post-processing is performed prior to transmitting the generated output for confirmation.

8. The computing platform of claim 1, wherein the mobile device is a wearable device.

9. The computing platform of claim 1, wherein the executing the one or more speech recognition techniques and the executing the one or more machine learning models is performed within an artificial intelligence trust, risk and security management (AITRiSM) framework.

10. A method, comprising:
receiving, by a computing platform, the computing platform having at least one processor, and memory, audio data from a user, wherein the audio data is captured by a mobile device of the user and the audio data is received via the mobile device of the user;
initiating, by the at least one processor and based on the received audio data, a transaction session;
executing, by the at least one processor, sound cancelling techniques to isolate the audio data;
comparing, by the at least one processor, the audio data to pre-stored user authentication data to determine whether the user is authenticated to the transaction session;
responsive to determining that the user is not authenticated to the transaction session, terminating, by the at least one processor, the transaction session;
responsive to determining that the user is authenticated to the transaction session:
extracting, by the at least one processor and from the audio data, features, wherein extracting the features results in an audio signal formatted for further processing;
executing, by the at least one processor, one or more speech recognition techniques on the audio signal to generate a plurality of phonetic units;
executing, by the at least one processor, one or more machine learning models, wherein executing the one or more machine learning models includes inputting, to the one or more machine learning models, the plurality of phonetic units to generate an output; and
transmitting, by the at least one processor and to the mobile device of the user, the generated output for confirmation.

11. The method of claim 10, further including:
receiving, by the at least one processor and in response to transmitting the generated output, feedback data; and
updating, by the at least one processor, the one or more machine learning models based on the feedback data.

12. The method of claim 10, wherein extracting the features includes executing one or more of: MFCCs or spectrograms.

13. The method of claim 10, wherein executing the one or more speech recognition techniques includes executing one or more of deep learning models, acoustic models or language models.

14. The method of claim 10, further including:
post-processing, by the at least one processor, the output to improve accuracy of the output.

15. The method of claim 14, wherein the post-processing includes error correction.

16. The method of claim 14, wherein the post-processing is performed prior to transmitting the generated output for confirmation.

17. The method of claim 10, wherein the mobile device is a wearable device.

18. The method of claim 10, wherein the executing the one or more speech recognition techniques and the executing the one or more machine learning models is performed within an AITRiSM framework.

19. One or more non-transitory computer-readable media storing instructions that, when executed by a computing platform comprising at least one processor, memory, and a communication interface, cause the computing platform to:
receive audio data from a user, wherein the audio data is captured by a mobile device of the user and the audio data is received via the mobile device of the user;
initiate, based on the received audio data, a transaction session;
execute sound cancelling techniques to isolate the audio data;
compare the audio data to pre-stored user authentication data to determine whether the user is authenticated to the transaction session;
responsive to determining that the user is not authenticated to the transaction session, terminate the transaction session;
responsive to determining that the user is authenticated to the transaction session:
extract, from the audio data, features, wherein extracting the features results in an audio signal formatted for further processing;
execute one or more speech recognition techniques on the audio signal to generate a plurality of phonetic units;
execute one or more machine learning models, wherein executing the one or more machine learning models includes inputting, to the one or more machine learning models, the plurality of phonetic units to generate an output; and
transmit, to the mobile device of the user, the generated output for confirmation.

20. The one or more non-transitory computer-readable media of claim 19, further including instructions that, when executed, cause the computing platform to:
receive, in response to transmitting the generated output, feedback data; and
update the one or more machine learning models based on the feedback data.
